(19) United States
(12) Patent Application Publication
(10) Pub. No.: US 2026/0251183 A1
(43) Pub. Date: Aug. 27, 2026

(54) Universal Joint

(71) Applicant: Monas Pump Co., Ltd., Siheung-si, Gyeonggi-do (KR)

(72) Inventor: Hoe Min LEE, Seocho-gu, Seoul (KR)

(21) Appl. No.: 18/871,059

(22) PCT Filed: Apr. 7, 2023
(86) PCT No.: PCT/KR2023/004741

§ 371 Date: Dec. 2, 2024

(30) Foreign Application Priority Data
Jun. 3, 2022 (KR) 10-2022-0068438

(51) Int. Cl. F16D 3/205

(52) U.S. Cl. CPC F16D 3/2052

(57) ABSTRACT

The present disclosure relates to a universal joint capable of maintaining an angular difference and a firm connection between a driving shaft and a driven shaft for complete power transmission by using only coupling members provided on an end of the driving shaft and a corresponding end of the driven shaft without the need for additional connection members. The universal joint includes a driven shaft including a first shaft portion and a joint key portion provided on an end of the first shaft portion, the joint key portion including a joint body and a joint arm protruding from the joint body; and a driving shaft including a second shaft portion and a joint holder portion provided on an end of the second shaft portion to correspond to the joint key portion, the joint holder portion including a body accommodation portion into which the joint body of the driven shaft is insertable, an arm slot into which the joint arm of the driven shaft is insertable, and a shaft slot into which the first shaft portion of the driven shaft is insertable.

### TECHNICAL FIELD

The present disclosure relates to a universal joint used as a shaft coupling in various mechanical devices for power transmission to efficiently transmit power to a driven body even when a driving shaft and a driven shaft are not aligned in parallel.

### Background Art

There are various shaft coupling methods for transmitting a rotational torque from a driving source to a driven body. Among such shaft coupling methods, a universal joint method is used when the rotation axes of a driving shaft and a driven shaft are not aligned with each other.

Universal joints are shaft couplings used when the center axes of two shafts intersect at an angle of about 30 degrees or less, and generally have a structure in which two shafts are connected to a pin positioned between the two shafts.

However, such shaft couplings of the related art (for example, universal joints) require a large number of mechanical elements to connect shafts, resulting in a complex structure and difficulty in assembly.

For instance, universal joints of the related art, depending on their type, require additional fastening elements such as joint covers, sleeves, and clamp rings to prevent pin separation, and also require bearings to ensure smooth rotation.

Furthermore, a pin used to connect a driving shaft and a driven shaft to each other may wear out or sustain damage during torque transmission.

In the related art, shaft couplings (for example, universal joints) are used in applications such as material transfer pumps, power transmission units in automobiles, and drive units of various mechanical products across different fields and environments. Also, such shaft couplings come in various sizes.

In particular, considering the role of shaft couplings (for example, universal joints), that is, the role of transmitting a rotational torque from a driving source to a driven body, it is common for shaft couplings to be used in harsh environments characterized by continuous vibrations, friction, and sometimes high temperatures and pressures.

Therefore, what is essentially needed is a simple, easy-to-manufacture structure capable of efficiently transmitting a rotational torque from a driving source to a driven body in various harsh environments.

For instance, shaft couplings used in material transfer pumps are required to include heat-resistant members to transfer high-temperature substances and to have enough durability to withstand high pressures required for pushing viscous substances.

In addition, shaft couplings used in fine mechanical products are required to be small enough to fit into the fine mechanical products while fulfilling their role of transmitting a rotational torque from a driving source to a driven body.

However, as mentioned above, shaft couplings of the related art (such as universal joints) require various members to connect shafts to each other. Thus, shaft couplings of the related art may not function properly under harsh environmental conditions, or it may be difficult to manufacture shaft couplings of the related art in a desired small size due to processing challenges caused by their structural complexity. Furthermore, assembling shaft couplings of the related art may often be difficult.

Therefore, a continuing challenge in the technical field of the present disclosure is to develop a simple, easy-to-manufacture shaft coupling structure that may be assembled with minimal fastening members and simple methods, while being able of efficiently transmitting a rotational torque from a driving source to a driven body in various harsh environments.

### DISCLOSURE

### Technical Problem

The present disclosure addresses the aforementioned problems by providing a universal joint capable of maintaining an angular difference and a firm connection between a driving shaft and a driven shaft for complete power transmission by using only coupling members provided on corresponding ends of the driving shaft and the driven shaft without the need for additional members.

### Technical Solution

To address the problems described above, a universal joint of the present disclosure may include a driven shaft including a first shaft portion and a joint key portion provided on an end of the first shaft portion, the joint key portion including a joint body and a joint arm protruding from the joint body; and a driving shaft including a second shaft portion and a joint holder portion provided on an end of the second shaft portion to correspond to the joint key portion, the joint holder portion including a body accommodation portion into which the joint body of the driven shaft is insertable, an arm slot into which the joint arm of the driven shaft is insertable, and a shaft slot into which the first shaft portion of the driven shaft is insertable, wherein the driven shaft and the driving shaft may be coupled to each other by inserting the joint arm of the joint key portion into the arm slot of the joint holder portion, and then, rotating the joint arm of the joint key portion.

According to an embodiment of the present disclosure, the driving shaft and the driving shaft may be coupled to each other by rotating the joint arm of the joint key portion inserted into the arm slot of the joint holder portion around an axis perpendicular to an axial direction of the second shaft portion.

According to an embodiment of the present disclosure, the joint body may extend from the end of the first shaft portion and have a curved end.

According to an embodiment of the present disclosure, the joint arm may have a pillar shape protruding in an axial direction perpendicular to an axial direction of the first shaft portion, and in a cross-section of the joint arm taken in a direction perpendicular to the axial direction in which the joint arm protrudes, a first width L1 may be greater than a second width L2, where the second width L2 is a width of the cross-section in a direction perpendicular to a direction in which the joint arm is inserted into the arm slot, and the first width L1 is a width of the cross-section in a direction perpendicular to the direction in which the joint arm is inserted into the arm slot, after the joint arm inserted into the arm slot is rotated.

According to an embodiment of the present disclosure, the joint arm may have a pillar shape protruding in an axial direction perpendicular to the axial direction of the first shaft portion, and a cross-section of the joint arm taken in a direction perpendicular to the axial direction in which the joint arm protrudes may have a rectangular shape with a width in a direction perpendicular to the axial direction of the first shaft portion greater than a width in the axial direction of the first shaft portion, at least one side of the rectangular shape being rounded.

According to an embodiment of the present disclosure, the joint arm may include at least two joint arms provided on the joint body.

According to an embodiment of the present disclosure, the arm slot may include a joint arm locking portion preventing the joint arm from separating from the arm slot after the joint arm inserted into the arm slot is rotated, and a slot width W1 of the joint arm locking portion may satisfy Inequality I below:

### [Inequality 1]

the second width L2 of the joint arm≤W1<the first width L1 of the joint arm.

According to an embodiment of the present disclosure, the arm slot may include a joint arm rotation portion extending from the joint arm locking portion in a direction toward the second shaft portion to allow the joint arm to rotate in the joint arm rotation portion, and the joint arm rotation portion may include a predetermined section having a slot width greater than or equal to the first width L1 of the joint arm.

According to an embodiment of the present disclosure, a slot depth H of the joint arm rotation portion may be greater than or equal to the first width L1 of the joint arm.

According to an embodiment of the present disclosure, the arm slot may include at least two arm slots.

According to an embodiment of the present disclosure, the shaft slot may include at least two shaft slots.

### Advantageous Effects

Owing to the configuration and coupling relationship described above, the present disclosure has the advantages of firmly coupling the driving shaft and the driven shaft to each other with a very simple structure while maintaining an angular difference between the driving shaft and the driven shaft, and because additional coupling members are not required, the driving shaft and the driven shaft are rarely separated from each other even when the universal joint of the present disclosure is used in a power system under a driving environment affected by frequent external vibrations.

In addition, the universal joint of the present disclosure includes only members resistant in harsh environments such as high temperatures and thus has the advantage of having far fewer environmental restrictions compared to universal joints of the related art.

Furthermore, the universal joint of the present disclosure may be easily attached and removed via a simple assembling method and may thus be easily maintained and repaired.

Moreover, because fewer coupling members are required compared to the related art, the universal joint of the present disclosure may be easily processed and highly cost-competitive owing to reduced production costs. In addition, the universal joint of the present disclosure may be manufactured only through injection molding processes and may thus be applied to even small items that are difficult to produce in the related art.

### DESCRIPTION OF DRAWINGS

FIG. 1 is a perspective view illustrating a universal joint according to an embodiment of the present disclosure.

FIG. 2 is a view sequentially illustrating a universal joint coupling method according to an embodiment of the present disclosure.

FIG. 3 is a view illustrating a driven shaft of the universal joint in a direction of an axis III according to an embodiment of the present disclosure.

FIG. 4 is a view illustrating the driven shaft of the universal joint in a direction of an axis II according to an embodiment of the present disclosure.

FIG. 5 is a view illustrating the driven shaft of the universal joint in a direction of an axis I according to an embodiment of the present disclosure.

FIG. 6 is a view illustrating a driving shaft of the universal joint in the direction of the axis II according to an embodiment of the present disclosure.

FIG. 7 is a view illustrating the driving shaft of the universal joint in the direction of the axis III according to an embodiment of the present disclosure.

FIG. 8 is a view illustrating the driving shaft of the universal joint in the direction of the axis I according to an embodiment of the present disclosure.

FIG. 9 is a view illustrating the universal joint in the direction of the axis II to show how the driven shaft connected to the driving shaft rotates, according to an embodiment of the present disclosure.

FIG. 10 is a view illustrating the universal joint in the direction of the axis III to show how the driven shaft connected to the driving shaft rotates, according to an embodiment of the present disclosure.

### MODE FOR INVENTION

The present specification aims to clearly define the scope of the present disclosure, explain the principles of the present disclosure, and disclose embodiments such that those of ordinary skill in the art may implement the present disclosure. The disclosed embodiments may be implemented in various forms.

Expressions such as “include” or “may include” may be used in various embodiments of the present disclosure to specify the presence of disclosed functions, operations, or elements, and do not preclude the presence or addition of one or more other functions, operations, or elements. In addition, terms such as “include” or “comprise” may be used in various embodiments of the present disclosure to specify the presence of stated features, fixed numbers, steps, processes, elements, components, or combinations thereof, but do not preclude the presence or addition of one or more other features, fixed numbers, steps, processes, elements, components, or combinations thereof.

It should be understood that when an element is referred to as being “connected” or “coupled” to another element, the element may be directly connected or coupled to the other element, or any other element may be disposed between the two elements. In contrast, it should be understood that when an element is referred to as being “directly connected” or “directly coupled” to another element, there is no other element between the two elements.

Although terms such as “first” and “second” are used herein to describe various elements, these elements should not be limited by these terms. These terms are only used to distinguish one element from other elements.

Terms such as “driving shaft” and “driven shaft” are used herein to clearly refer to one of two shafts forming a joint coupling and involved in power transmission. It should not be interpreted that the driving shaft necessarily refers to a shaft with a power source connected to an end thereof, nor that the driven shaft necessarily refers to a shaft with no power source connected to any end thereof. Therefore, as described below, a joint holder portion may be provided on an end of the driving shaft, and a joint key portion may be provided on an end of the driven shaft.

Hereinafter, preferred embodiments of the present disclosure will be described in detail with reference to the drawings.

The present disclosure relates to a universal joint used to fully transmit power in various mechanical devices in which power transmission occurs, such as pumps and automobiles, even when a driving shaft 200 and a driven shaft 100 are not aligned in parallel.

Specifically, the present disclosure relates to a universal joint capable of maintaining an angular difference and a firm connection between a driving shaft 200 and a driven shaft 100 for complete power transmission by using only coupling members provided on an end of the driving shaft 200 and a corresponding end of the driven shaft 100 without the need for additional connection members.

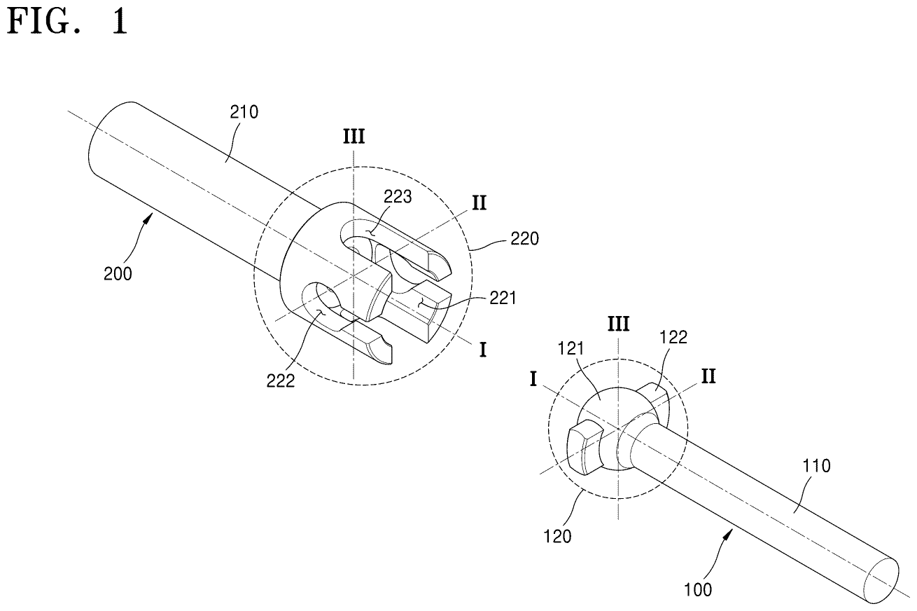

To this end, referring to FIG. 1, according to an embodiment of the present disclosure, a universal joint includes a driven shaft 100 including a first shaft portion 110 and a joint key portion 120 provided on an end of the first shaft portion 110; and a driving shaft 200 including a joint holder portion 220 corresponding to the joint key portion 120 and provided on an end of a second shaft portion 210.

In this case, the joint key portion 120 of the driven shaft 100 may include a joint body 121 and a joint arm 122 protruding from the joint body 121. In addition, the joint holder portion 220 of the driving shaft 200 may include a body accommodation portion 221 into which the joint body 121 of the driven shaft 100 is insertable, an arm slot 222 into which the joint arm 122 of the driven shaft 100 is insertable, and a shaft slot 223 into which the first shaft portion 110 of the driven shaft 100 is insertable.

Next, the driven shaft 100 and the driving shaft 200 may be coupled to each other by inserting the joint arm 122 of the joint key portion 120 into the arm slot 222 of the joint holder portion 220, and then, rotating the joint arm 122 of the joint key portion 120.

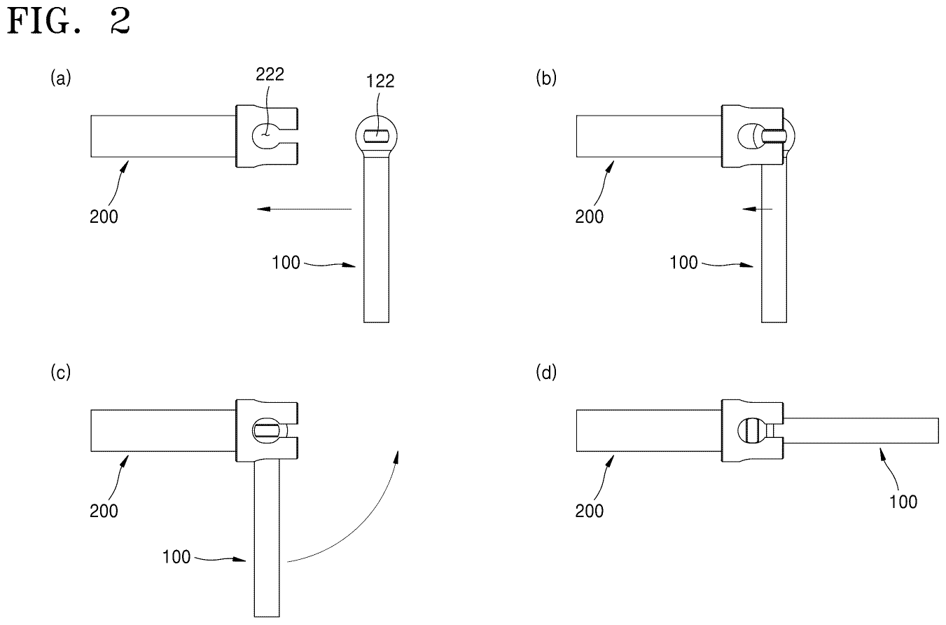

For example, referring to FIGS. 1 and 2, the driven shaft 100 and the driving shaft 200 may be coupled to each other by inserting the joint arm 122 of the joint key portion 120 into the arm slot 222 of the joint holder portion 220 at a predetermined angle, and then, rotating the joint arm 122 inserted into the arm slot 222 around an axis (axis II in FIG. 1) perpendicular to an axis (axis I shown in FIG. 1) of the second shaft portion 210 with the center of the joint arm 122 as the center of rotation.

As described above, the universal joint of the embodiment of the present disclosure is advantageous in that the driven shaft 100 and the driving shaft 200 may be coupled to each other in a very simple way by inserting the joint arm 122 into the arm slot 222 and rotating the joint arm 122.

Hereinafter, based on the coupling method described above, each element of the present disclosure will be described in detail.

The driven shaft 100 will be described in detail with reference to FIGS. 1 and 3 to 5.

Referring to FIG. 1, the driven shaft 100 may include the first shaft portion 110 and the joint key portion 120 that extends from the end of the first shaft portion 110 and serves as a key when the driven shaft 100 and the driving shaft 200 are coupled to each other by a joint coupling method.

First, the first shaft portion 110 is a shaft commonly used in mechanical devices for power transmission, and the specific shape of the first shaft portion 110, such as thickness and length, is not limited. It should be understood that the shape of the first shaft portion 110 is determined according to the environment or condition in which the universal joint of the present disclosure is used.

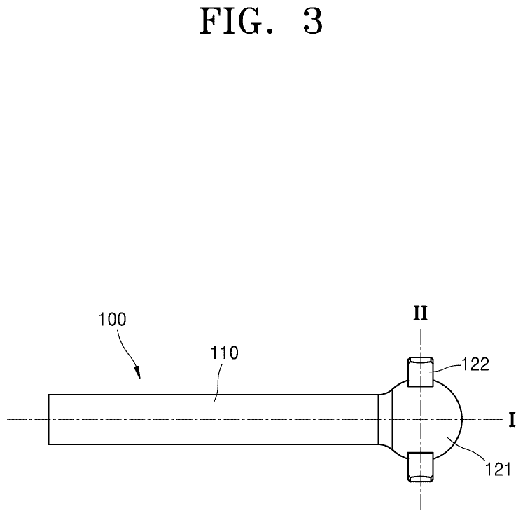

Next, referring to FIGS. 1 and 3, the joint key portion 120 may include the joint body 121 and the joint arm 122.

In this case, the joint body 121 may serve as a main body of the joint key portion 120, extend from the end of the first shaft portion 110, and have a curved surface on an end thereof.

Specifically, the curved surface of the end of the joint body 121 is provided to facilitate responding to an angular difference or change between the driven shaft 100 and the driving shaft 200 after the joint body 121 is inserted into the body accommodation portion 221 of the joint holder portion 220. For example, the end of the joint body 121 may have a hemispherical curved surface.

In addition, the joint arm 122 protrudes from the joint body 121 to serve as a key of the joint key portion 120.

Specifically, as described below, due to the shape of the joint arm 122, the joint arm 122 is allowed to enter or leave the arm slot 222 of the joint holder portion 220 only in a condition in which the driven shaft 100 and the driving shaft 200 maintain an angle at the time the joint arm 122 is inserted into the arm slot 222.

However, when the joint arm 122 inserted into the arm slot 222 rotates around an axis (axis II in FIG. 1) perpendicular to the axis (axis I in FIG. 1) of the second shaft portion 210, the angle between the driven shaft 100 and the driving shaft 200 changes from the angle of insertion, and the entry and exit of the joint arm 122 are restricted by a joint arm locking portion 222(a) (described later) of the arm slot 222 such that the joint arm 122 may serve as a key connecting the driven shaft 100 and the driving shaft 200 to each other.

In addition, the joint arm 122 may have a pillar shape protruding in the direction of an axis (axis II in FIG. 1) perpendicular to an axis (axis I in FIG. 1) of the first shaft portion 110.

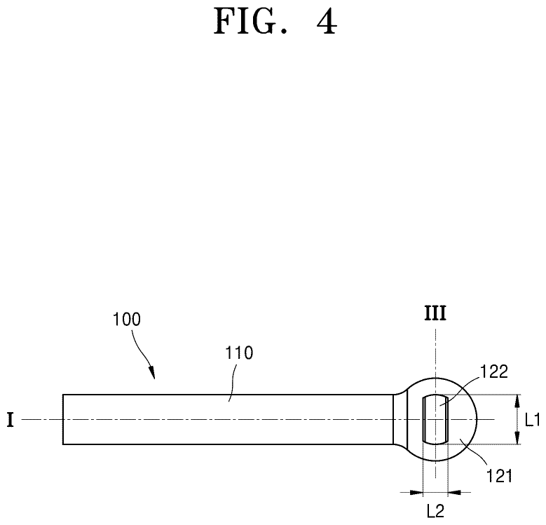

In addition, referring to FIGS. 1 and 4, a cross-section (parallel to a plane I-III in FIG. 4) of the joint arm 122, which is taken in a direction perpendicular to the axis (axis II shown in FIG. 1) along which the joint arm 122 protrudes, may have: a second width L2 in a direction (the direction of an axis III of the driving shaft 200 in FIG. 1) perpendicular to the direction (the direction of an axis I of the driving shaft 200 in FIG. 1) in which the joint arm 122 is inserted into the arm slot 222; and a first width L1 which collectively refers to a width in a direction perpendicular to the direction in which the joint arm 122 is inserted into the arm slot 222 after the joint arm 122 inserted into the arm slot 222 is rotated around an axis (axis II in FIG. 1) perpendicular to the axis (axis I in FIG. 1) of the second shaft portion 210, wherein the first width L1 may be greater than the second width L2.

However, the joint arm 122 is not limited thereto. It may be interpreted that the scope of the present disclosure includes the case in which a cross-section of the joint arm 122, taken in a direction perpendicular to an axis of the protruding pillar shape of the joint arm 122, has any shape, except for a shape such as a circular shape having a constant width when passing through the arm slot 222, as long as the cross-section of the joint arm 122 has a shape extending in one direction such that the width of the cross-section of the joint arm 122 passing through the arm slot 222 may vary depending on the rotation of the joint arm 122.

For example, referring to FIGS. 1 and 4, a cross-section (parallel to the plane I-III in FIG. 4) of the joint arm 122 taken in a direction perpendicular to the axis (axis II in FIG. 1) along which the joint arm 122 protrudes may have a rectangular shape with a width in the direction of the axis III being greater than a width in the direction of the axis I. Alternatively, the cross-section of the joint arm 122 may have an elliptical shape with a major axis in the direction of the I axis III of the driven shaft 200 or 100.

In this case, at least one protruding surface of the joint arm 122 may be rounded to handle an angular difference or change between the driven shaft 100 and the driving shaft 200, as intended in embodiments of the present disclosure.

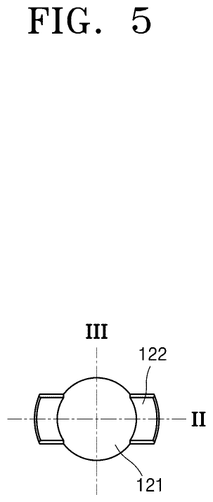

Referring to FIGS. 1 and 5, at least two joint arms 122 may be provided on the joint body 121. In this case, preferably, the at least two joint arms 122 may be symmetrically provided on the joint body 121 around the axis (axis I in FIG. 1) of the driven shaft 100.

Next, the Driving Shaft 200 Will Be Described in Detail With Reference to FIGS. 1 and 6 to 8.

Referring to FIG. 1, the driving shaft 200 may include the second shaft portion 210 and the joint holder portion 220 that is provided on the end of the second shaft portion 210 and corresponds to the joint key portion 120 of the driven shaft 100.

First, like the driven shaft 100 described above, the driving shaft 200 is a shaft commonly used in mechanical devices for power transmission, and the specific shape of the driving shaft 200, such as thickness and length, is not limited. It should be understood that the shape of the driving shaft 200 is determined according to the environment or condition in which the universal joint of the present disclosure is used according to embodiments.

Next, referring to FIG. 1, the joint holder portion 220 may include the body accommodation portion 221, the arm slot 222, and the shaft slot 223.

Here, the body accommodation portion 221 provides a space into which the joint body 121 of the joint key portion 120 of the driven shaft 100 is inserted, and is recessed to a predetermined depth from an end of the joint holder portion 220 in the direction of the second shaft portion 210.

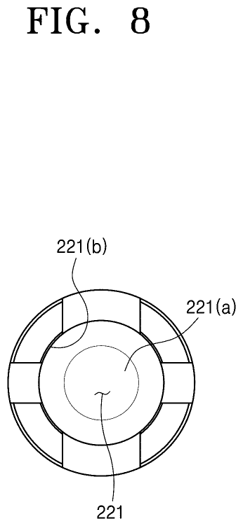

Referring to FIG. 8, the body accommodation portion 221 may be divided into a body accommodating bottom surface 221(a) and a body accommodation side surface 221(b), and the body accommodation bottom surface 221(a) may be provided as a curved surface that is recessed corresponding to the curved surface of the end of the joint body 121.

For example, the body accommodation bottom surface 221(a) may be provided as a hemispherical curved surface that is recessed in the direction of the second shaft portion 210.

In addition, the body accommodation side surface 221(b) may be rounded and recessed toward the outside of the joint holder portion 220 according to the curved surface of the joint body 121.

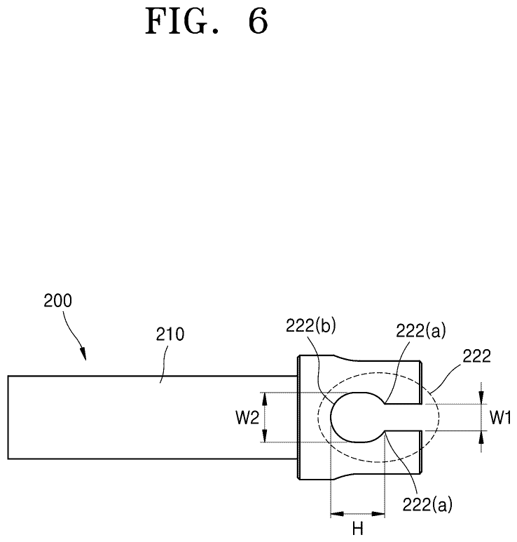

Next, referring to FIGS. 1 and 6, the arm slot 222 may be shaped such that the driven shaft 100 and the driving shaft 200 may be coupled to each other by inserting the joint arm 122 of the driven shaft 100 into the arm slot 222, and then, rotating the joint arm 122 around an axis (axis II in FIG. 1) perpendicular to the axis (axis I in FIG. 1) of the second shaft portion 210 as described above.

Specifically, the arm slot 222 may communicate with the outside of the joint holder portion 220 in a direction from the body accommodation portion 221 to an outer surface of the joint holder portion 220 and may also be recessed in a direction from an end of the joint holder portion 220 toward the second shaft portion 210.

In addition, the arm slot 222 may include the joint arm locking portion 222(a) and a joint arm rotation portion 222(b).

Specifically, the joint arm locking portion 222(a) may prevent separation of the joint arm 122 from the arm slot 222 after the joint arm 122 is inserted into the arm slot 222 and is rotated. The joint arm locking portion 222(a) may be at a predetermined depth from the end of the joint holder portion 220.

Next, the joint arm rotation portion 222(b) may extend from the joint arm locking portion 222(a) toward the second shaft portion 210 and include a predetermined space to allow the joint arm 122 to rotate within the arm slot 222 around an axis (axis II in FIG. 1) perpendicular to the axis of the second shaft portion 210.

In this case, a slot width W1 of the joint arm locking portion 222(a) may satisfy Inequality I below: (In inequality 1, a slot width refers to the distance between walls forming the slot, and for example, W1 and W2 shown in FIG. 6 are examples of slot widths)

### [Inequality 1]

Second width L2 of joint arm≤W1<first width L1 of joint arm

Specifically, the slot width W1 of the joint arm locking portion 222(a) is greater than the second width L2 of the joint arm 122, and thus, the joint arm 122 may pass through the joint arm locking portion 222(a).

However, when the width of the joint arm 122 in a direction (for example, the direction of the axis III of the driving shaft 200 in FIG. 1) perpendicular to the insertion direction (for example, the direction of the axis I in FIG. 1) of the joint arm 122 is the first width L1 due to the rotation of the joint arm 122, the joint arm 122 may no longer pass through the joint arm locking portion 222(a).

Therefore, owing to the joint arm locking portion 222(a), the joint arm 122 may be inserted into the arm slot 222 at a predetermined angle, and then, when rotated, the joint arm 122 may be prevented from exiting the arm slot 222 in the original insertion direction of the joint arm 122.

For example, referring to FIGS. 2, 4, and 6, the joint arm 122 may enter or exit the arm slot 222 with the second width L2, and in this case, the driven shaft 100 and the driving shaft 200 are positioned to be perpendicular to each other.

Afterward, when the axis of the driven shaft 100 and the axis of the driving shaft 200 are aligned with each other as the joint arm 122 rotates within the joint arm rotation portion 222(b) of the arm slot 222, the first width L1 of the joint arm 122 may not pass through the slot width W1 of the joint arm locking portion 222(a), thereby guaranteeing firmly coupling between the driven shaft 100 and the driving shaft 200.

Next, a slot depth (H) of the joint arm rotation portion 222(b) extending from the joint arm locking portion 222(a) toward the second shaft portion 210 may be greater than or equal to the first width L1 of the joint arm 122.

This may be understood as a condition for the joint arm 122 to rotate within the joint arm rotation portion 222(b) around an axis (axis II in FIG. 1) perpendicular to the axis of the second shaft portion 210.

Next, referring to FIGS. 1, 6, and 10, the joint arm rotation portion 222(b) may include a section in which a slot width of the joint arm rotation portion 222(b) is greater than or equal to the first width L1 of the joint arm 122.

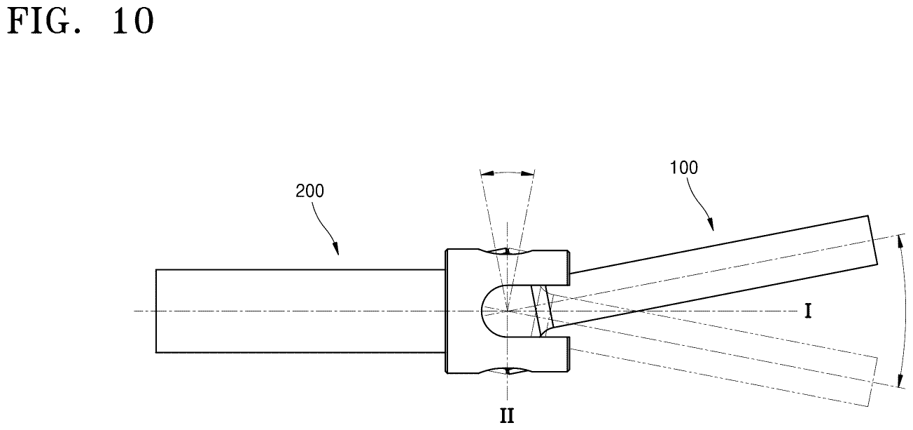

This structure allows the driven shaft 100 to rotate by a predetermined angle on the plane I-II of the driving shaft 200 as shown in FIG. 10, and may be provided in various forms by considering a desired rotation angle (this structure should be understood as including the case in which the driven shaft 100 is allowed to rotate only on the plane I-III of the driving shaft 200 but is fixed with respect to the plane I-II of the driving shaft 200 to prevent the driven shaft 100 from rotating on the plane I-II of the driving shaft 200).

For example, referring to FIG. 6, the joint arm rotation portion 222(b) may not have a complete circle shape but have a predetermined straight section with a slot width W2 that is greater than or equal to the first width L1 of the joint arm 122. However, the joint arm rotation portion 222(b) is not limited thereto and may be provided in various shapes such as a curved shape as long as the joint arm rotation portion 222(b) has a section with a slot width greater than or equal to the first width L1 of the joint arm 122.

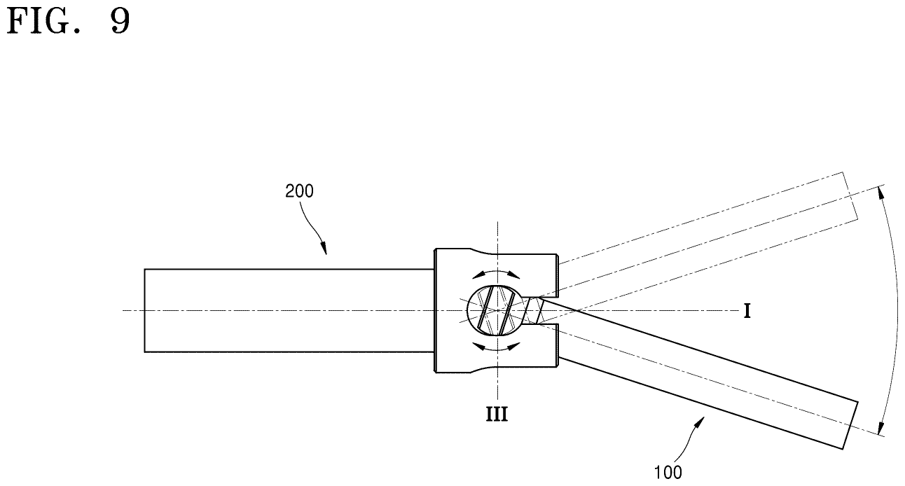

Next, referring to FIG. 9, while satisfying the slot width and depth requirements, the joint arm rotation portion 222(b) may be rounded to ensure smooth rotation of the joint arm 122 inserted into the joint arm rotation portion 222(b).

Next, referring to FIGS. 1 and 8, at least two arm slots 222 may be provided in the joint holder portion 220. Preferably, the at least two arm slots 222 may be symmetrically provided around the axis of the second shaft portion 210 according to joint arms 122.

Next, the shaft slot 223 will be described with reference to FIGS. 1, 7, 8, and 9.

When the joint arm 122 is inserted into the arm slot 222, the driven shaft 100 and the driving shaft 200 are not parallel with each other, and thus, it is necessary to insert the driven shaft 100 into the joint holder portion 220 at a predetermined angle for inserting the joint arm 122 into the arm slot 222. Due to this, the shaft slot 223 is provided.

Thus, the shaft slot 223 is provided in a side of the joint holder portion 220 according to a protruding direction relationship between the first shaft portion 110 and the joint arm 122.

For example, referring to FIGS. 1 and 8, the joint arm 122 protrudes from the joint body 121 in a direction perpendicular to the first shaft portion 110, and thus, the shaft slot 223 may be provided at a position perpendicular to the arm slot 222 with respect to the axis of the second shaft portion 210. The shaft slot 223 may be defined from the body accommodation portion 221 and communicate with the outside of the joint holder portion 220.

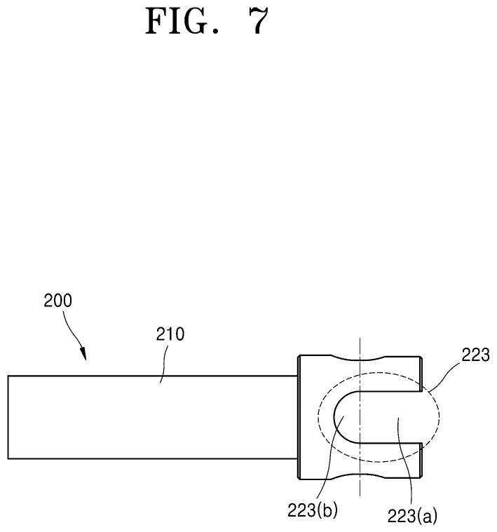

Next, referring to FIG. 7, the shaft slot 223 may be divided into an upper shaft slot 223(a) and a lower shaft slot 223(b), and the lower limit of the width of the upper shaft slot 223(a) may be the diameter of the first shaft portion 110.

In addition, the lower shaft slot 223(b) may be provided with a predetermined curvature to match an outer surface of the first shaft portion 110.

Next, referring to FIGS. 1, 8, and 9, preferably, at least two shaft slots 223 may be provided in the joint holder portion 220 such that the driven shaft 100 may sufficiently rotate on the plane I-III of the driving shaft 200.

Hereinafter, with reference to FIGS. 1, 2, 9, and 10, the method of assembling the universal joint of the present disclosure will be summarized, and a method of operating the universal joint will be described.

Referring to FIGS. 1 and 2, according to an example of the assembling method, the joint arm 122 of the driven shaft 100 is inserted into the arm slot 222 of the driving shaft 200 in a state in which the driven shaft 100 is perpendicular to the driving shaft 200, and then, the driven shaft 100 is rotated around an axis perpendicular to the axis of the second shaft portion 210, thereby coupling the driven shaft 100 and the driving shaft 200 to each other.

Referring to FIG. 9, in this assembled state of the universal joint, the driving shaft 200 and the driven shaft 100 may form a predetermined angle on the plane I-III of the driving shaft 200, owing to the joint arm rotation portion 222(b) provided in the arm slot 222 to allow rotation of the joint arm 122 and the shaft slot 223 provided in the joint holder portion 220 to partially receive the first shaft portion 110.

Referring to FIG. 10, in the assembled state of the universal joint, the driving shaft 200 and the driven shaft 100 may form a predetermined angle on the plane I-II of the driving shaft 200 because the arm slot 222 has a section with a width greater than the first width L1.

In other words, according to an embodiment of the present disclosure, the driven shaft 100 and the driving shaft 200 of the universal joint may be firmly coupled to each other by a simple method of inserting the driven shaft 100 into the driving shaft 200 in a specific direction and then rotating the driven shaft 100. In addition, the driven shaft 100 and the driving shaft 200 may form a predetermined angle. Thus, power may be efficiently transmitted in a direction not parallel to the driving shaft 200.

In addition, the function of the universal joint may be performed only with the coupling members (the joint key portion 120 and the joint holder portion 220) provided on the ends of the driven shaft 100 and the driving shaft 200, and thus, it may be easily expected that even when the universal joint of the present disclosure is used in a power system under a driving environment affected by frequent external vibrations, the driven shaft 100 and the driving shaft 200 may be rarely separated from each other.

Along with this, the number of members of the universal joint to be manufactured is small, and thus, the universal joint may be easily processed and may be competitive in terms of production and maintenance costs.

These advantages are highly encouraging and advanced, considering that developing a universal joint that may be assembled with a minimal number of coupling members and simple methods has been a continuous challenge in the technical field of the present disclosure.

The above description of the present disclosure is provided for illustration, and it will be understood by those of ordinary skill in the art that changes in form and details may be readily made therein without departing from technical idea or essential features of the present disclosure. Therefore, the above embodiments and all aspects thereof are merely examples and are not limiting.

For example, while the present disclosure has been described with reference to embodiments illustrated in the drawings, the embodiments are merely examples, and those skilled in the art will understand that various modifications may be made in or from the embodiments.

Therefore, the technical scope of the present disclosure is defined by the appended claims, and all changes or modifications derived from the meaning and scope of the claims and their equivalent concepts should be interpreted as being included in the scope of the present disclosure.

1. A universal joint comprising:
a driven shaft comprising a first shaft portion and a joint key portion provided on an end of the first shaft portion, the joint key portion comprising a joint body and a joint arm protruding from the joint body; and
a driving shaft comprising a second shaft portion and a joint holder portion provided on an end of the second shaft portion to correspond to the joint key portion, the joint holder portion comprising a body accommodation portion into which the joint body of the driven shaft is insertable, an arm slot into which the joint arm of the driven shaft is insertable, and a shaft slot into which the first shaft portion of the driven shaft is insertable,
wherein the driven shaft and the driving shaft are coupled to each other by inserting the joint arm of the joint key portion into the arm slot of the joint holder portion, and then, rotating the joint arm of the joint key portion.

2. The universal joint of claim 1, wherein the driving shaft and the driving shaft are coupled to each other by rotating the joint arm of the joint key portion inserted into the arm slot of the joint holder portion around an axis perpendicular to an axial direction of the second shaft portion.

3. The universal joint of claim 1, wherein the joint body extends from the end of the first shaft portion and has a curved end.

4. The universal joint of claim 2, wherein the joint arm has a pillar shape protruding in an axial direction perpendicular to an axial direction of the first shaft portion, and
in a cross-section of the joint arm taken in a direction perpendicular to the axial direction in which the joint arm protrudes, a first width L1 is greater than a second width L2,
wherein the second width L2 is a width of the cross-section in a direction perpendicular to a direction in which the joint arm is inserted into the arm slot, and
the first width L1 is a width of the cross-section in a direction perpendicular to the direction in which the joint arm is inserted into the arm slot, after the joint arm inserted into the arm slot is rotated.

5. The universal joint of claim 4, wherein the joint arm has a pillar shape protruding in an axial direction perpendicular to the axial direction of the first shaft portion, and
a cross-section of the joint arm taken in a direction perpendicular to the axial direction in which the joint arm protrudes has a rectangular shape with a width in a direction perpendicular to the axial direction of the first shaft portion greater than a width in the axial direction of the first shaft portion, at least one side of the rectangular shape being rounded.

6. The universal joint of claim 1, wherein the joint arm comprises at least two joint arms provided on the joint body.

7. The universal joint of claim 4, wherein the arm slot comprises a joint arm locking portion preventing the joint arm from separating from the arm slot after the joint arm inserted into the arm slot is rotated,
and a slot width W1 of the joint arm locking portion satisfies Inequality I below:
[Inequality 1]
the second width L2 of the joint arm≤W1<the first width L1 of the joint arm.

8. The universal joint of claim 7, wherein the arm slot comprises a joint arm rotation portion extending from the joint arm locking portion in a direction toward the second shaft portion to allow the joint arm to rotate in the joint arm rotation portion, and
the joint arm rotation portion comprises a predetermined section having a slot width greater than or equal to the first width L1 of the joint arm.

9. The universal joint of claim 8, wherein a slot depth H of the joint arm rotation portion is greater than or equal to the first width L1 of the joint arm.

10. The universal joint of claim 1, wherein the arm slot comprises at least two arm slots.

11. The universal joint of claim 1, wherein the shaft slot comprises at least two shaft slots.
